(19) United States
(12) Patent Application Publication
(10) Pub. No.: US 2017/0039522 A1
(43) Pub. Date: Feb. 9, 2017

(54) Method of Identifying Relationships Between Service Professionals and Service Entities

(71) Applicants: Madelyn Martin, Argyle, TX (US); Todd Hayes, Argyle, TX (US); John E. Foster, Argyle, TX (US); Karen Winters, Argyle, TX (US)

(72) Inventors: Madelyn Martin, Argyle, TX (US); Todd Hayes, Argyle, TX (US); John E. Foster, Argyle, TX (US); Karen Winters, Argyle, TX (US)

(21) Appl. No.: 15/227,812

(22) Filed: Aug. 3, 2016

Related U.S. Application Data
(60) Provisional application No. 62/201,561, filed on Aug. 5, 2015.

(51) Int. Cl. G06Q 10/10

(52) U.S. Cl. CPC G06Q 10/105

(57) ABSTRACT

The present invention relates to a method identifying relationships between professionals and other industry entities by assigning codes in categories and combining the codes to indicate a unique entity with discernable relationships. The method can be used to store information that describes different entities separately, while tracking relationships by applying alpha-numeric codes that identify a relationship when combined. The method creates and assigns codes to identify specific categories. The assigned codes from each category are combined in order to identify a specific entity by the relationship an individual has with other entities in other categories. Ultimately, a code can be identified for every unique relationship an individual professional has with other entities, including working relationships with other individuals.

### STATEMENT OF PRIORITY

The foregoing application claims the benefit of U.S. Provisional Application No. 62/201,561 filed on Aug. 5, 2015 and is entitled “Method of Identifying Relationships between Financial Professionals and Other Financial Services Entities.”

### BACKGROUND OF THE INVENTION

Field of the Invention

The present invention relates generally to systems and methods of identifying relationships between service professionals and service entities.

Background

Currently, there are a number of solutions for tracking service professionals (financial services professionals, attorneys, real estate professionals, insurance professionals) including methods used by government agencies, commercial sources, and firms that employ the aforementioned service professionals.

With respect to financial services professionals, Federal systems match registered advisors with broker/dealers as it is necessary to conduct legal financial transactions. In Federal systems, office locations and other contact information for individual advisors, is not accurately tracked, and is often erroneous. Accurate advisor tracking is further exacerbated when considering non-registered firms and non-registered support personnel largely go untracked. Further this, Team information is not tracked. Referring to FIGS. 4 and 6, the method includes defining team attributes to identify working relationships within an established team of two or more individuals who work together under either a financial arrangement or a functional arrangement. In the current marketplace, the same individual may have relationships with multiple teams across multiple locations and on behalf of multiple firms.

While State and Federal Government systems compile office locations information for various types of registered advisors on a regular basis, they rely on manual inputs from the firms being tracked. Third party commercial services gather information from Government, agency, and other sources. Records are often tracked at the branch level alone to avoid the complexities of maintaining records on the individual level. Again, even these systems have flaws as non-registered personnel and team information are not usually tracked. Tracking individuals and relationships is key within the Financial Services industry has a disproportionally high-volume of individual movement. Financial services companies, such as mutual fund companies, employ large numbers of personnel in order to reconcile and update their records in an attempt to track movement. Once collected, each company employs their own method of organizing and tracking advisors. Non-licensed personnel, who are often decision makers, are not tracked at all. Financial professional movement averages 5-8% monthly, which creates a large amount of work for companies trying to maintain an accurate repository of information. Additionally, with the increasing amount of team relationships, partnership transactions, and dual registrations, firms are often unsure whether records are obsolete, duplicative, or erroneous.

Team information for these firms is acquired more slowly than with individual advisors. Indeed, it is difficult to track team information due to the lack of a standard methodology to identify groups and partnerships and their associated individual contributors. Further, a growing number of independent professionals are collecting revenue on the basis of fees rather than commissioned transactions, and are not tracked at all by conventional sources. Even for diligent financial services firms who continuously update relationship information, the structural deficiency of including all relevant attributes for an individual and his or her relationships in a single record, makes it nearly impossible to accurately track relationships and behaviors due to the continuous changes in individual attributes and relationships.

Because of the high volume of movement in the financial services industry, tracking financial professionals and their activities has always been a substantial effort for financial services companies. Additionally, changes in financial professional working relationships in the last decade have made the tracking effort even more cumbersome. The Patriot Act and know-your-customer (KYC) regulations motivate professionals to work in teams rather than alone in order to better understand their customers' financial relationships and manage risk, thereby increasing the formations of groups and partnerships in the industry. Additionally, the Registered Independent Adviser (RIA) business model is a popular alternative to standard hierarchical organizational structures within larger broker/dealers as it offers more autonomous work and focuses on building relationships with private investors. RIA personnel are not typically tracked by conventional sources.

Financial professionals increasingly work with multiple teammates, in multiple locations, and multiple firms/dealers. As a result, record keeping has become exceedingly complex. The added complexity of multiple working relationships has resulted in financial firms having large amounts of erroneous, unclassified, duplicate, and out-of-date information. This erroneous data is difficult to parse and assign to individual professionals. The difficulty required to accurately track an individual according to their relationships, locations, sales, and specialty, continues to expand exponentially and represents an exorbitant cost proposition. Therefore, there is an immediate need for a method of identification that is easily executed and that clearly identifies entities by their working relationships in the industry and results in reduced cost.

### SUMMARY OF THE INVENTION

The present invention advantageously addresses the aforementioned deficiencies by providing systems and methods for identifying relationships between service professionals and services entities, providing a concise framework for tracking individual professionals across multiple working relationships. The present invention maintains information that describes different entities separately, while tracking relationships by applying codes that can identify a service professional's working relationship as a unique entity. In order to carry out this method, the method creates and assigns codes to an infinite number of identifying categories and combines each assigned code in order to identify a unique entity.

The present method may also include one of the following steps:
Assign attributes to one or more entities in a category, cataloging them according to their unique category code; and
Divide category codes further to indicate more specific relationships. By way of example, for the Team category, one alphanumeric code may describe a Group (G), which is a functional designation that includes two or more people working in similar or complementary roles for a common purpose. Another Team alphanumeric code may describe a Partnership (P) relationship, which indicates a revenue sharing agreement between professionals on one or more transactions. These relationships are readily apparent by the contents of the Team code.

It is a further an object of the present invention to reduce the labor and expense required when updating records related to service professionals. Further still, it is an object of the present invention to provide a concise method and framework for documenting non-registered financial entities including independent firms, teams, representatives, and support personnel. Further still, it is an object of the present invention to provide a concise method and framework with which to capture and store professional information with relation to their specific industry relationships.

The present invention now will be described more fully below with reference to the accompanying drawings, which are intended to be read in conjunction with this summary, the detailed description and any preferred and/or particular embodiments specifically discussed or otherwise disclosed. This invention may, however, be embodied in many different forms and should not be construed as limited to the embodiments set forth herein. Rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is an architectural diagram illustrating a framework used for identifying individual relationships with other entities using this method;

FIG. 2 is a table illustrating the first of four exemplary category indices, the Firm Category, with representative codes in the first column identifying specific firms in the index and their associated attributes;

FIG. 3 is a table illustrating the second of four exemplary category indices, the Location Category, with representative codes in the first column identifying specific locations in the index and their associated attributes;

FIG. 4 is a table illustrating the third of four exemplary category indices, the Team Category, with representative codes in the first column identifying specific Groups (G) or Partnerships (P) contained in the index and their associated attributes;

FIG. 5 is a table illustrating the fourth of four exemplary category indices, the Individual Category with representative codes in the first column identifying specific individuals in the index and their associated attributes;

FIG. 6 is a table illustrating the combination of the four categories and the resulting codes. Each row in the figure identifies a unique entity using the same individual by listing the applicable codes for firms, locations, and teams with whom the individual has a specific working relationship; and

FIG. 7 is an architectural diagram illustrating the same framework used for identifying individual relationships as shown in FIG. 1, but with category names customized for the financial services industry. The exemplary categories in FIG. 7 are named Dealer (D), Branch (B), Team (T), and Representative (R) to reflect language commonly used in the financial services industry.

### DETAILED DESCRIPTION OF THE INVENTION

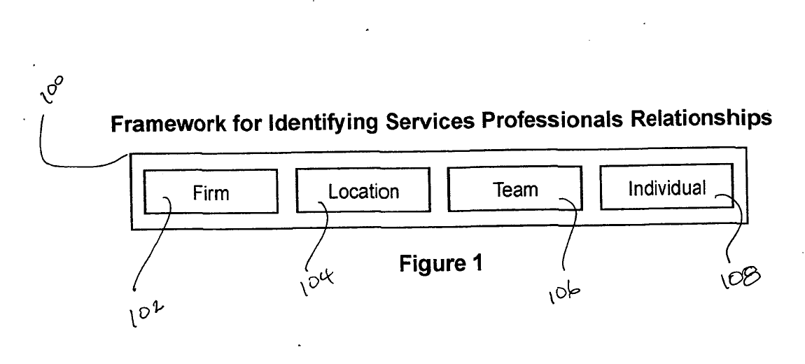

FIGS. 1-7, described in detail below, illustrate an exemplary embodiment of the present invention. The present invention is directed to a method of identifying relationships between service professionals and other services entities. Although some descriptions below reference financial services professionals, the method may be applied to any and all professional services entities. FIG. 1 is an architectural diagram illustrating an exemplary framework used for identifying individual relationships with other entities using this method. Element 100 illustrates a framework for identifying service professional relationships having manipulatable categories. As shown in FIG. 1, framework 100 has exemplary categories Firm 102, Location 104, Team 106, and Individual 108. The architecture illustrates an example of an unique entity code by combining representative codes for a specific firm, a specific location, a specific team, and a specific individual. The specificity of the entity by combining four categories is important because it does not include relationships or transactions outside of the categories defined, and as such, cannot be confused with other entities with different attributes. More categories may be added to further increase entity specificity if it would benefit the method in identifying a more precise entity. Similarity, categories can be removed to decrease entity specificity.

Firm category 102 is a representation of a specific firm or business entity using an assigned code. Location category 104 is a representation of specific physical address using an assigned code. Team category 106 is a representation of a team of two or more individuals with either a revenue sharing relationship or a functional work relationship using an assigned code. Individual category 108 is a representation of a specific individual using an assigned code.

As an illustrative example of performing the claimed method, codes are created for Firm Category 102. Next, the created codes are assigned to Firm Category 102. The codes can be any one of an alphanumeric, binary, hexagonal, decimal code or octagonal code or any other code capable of distinguishing one attribute from another. Firm Category 102 may include any company involved in financial services and is not limited solely to Broker/Dealers licensed to trade securities. Firm category codes are stored in an index for Firm Category 102. Moreover, descriptive attributes are assigned as needed, as they relate to particular firms in the Firm Category index. Following the creation and assigning of codes to Firm Category 102, at least one code is created and assigned for Location Category 104. Location Category 104 contains a worldwide listing of physical and virtual addresses. Descriptive attributes are assigned as needed, as they relate to particular locations in the Location Category Index. Next, at least one code created and assigned for Team Category 106. A team in Team Category 106 is comprised of two or more individuals who have a working relationship.

Teams in Team Category 106 are divided into two subcategories, namely, groups and partnerships. A group is a team of two or more individuals who have a functional relationship and most often perform different or complimentary tasks. A partnership generally indicates the presence of a revenue sharing agreement between one or more professionals for one or more transactions. Groups and partnerships maintain a separate coding rationale so each respective subcategory can be readily identified, while permitting the existence of both codes within the Team Category Index. Descriptive attributes are assigned as needed in the Team Category Index. Finally, at least one code is created and assigned for Individuals Category 108. Individuals listed in Individuals Category 108 have a unique code that identifies each individual. A myriad of attributes may be assigned in the Individual Category Index that are unique to that individual. For Financial Services, individuals may be professionals, support staff, management, or any other industry persons that may have a working relationship with a financial professional. In fact, the same is true for other service industries/entities.

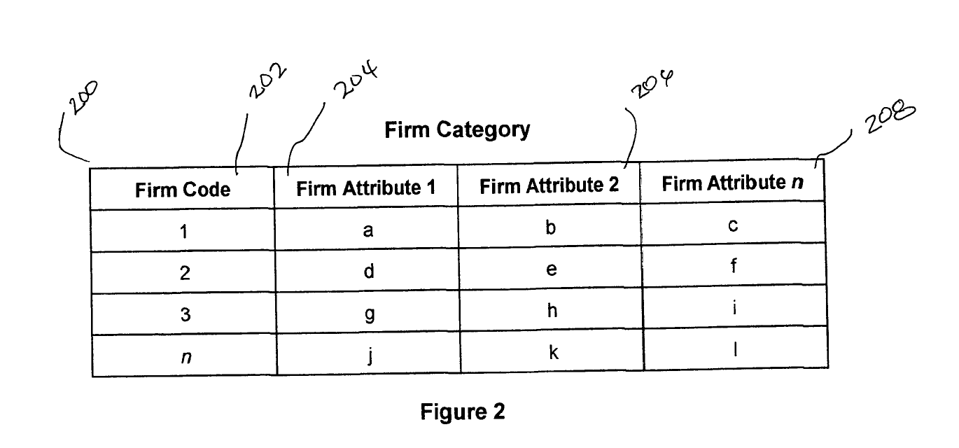

FIG. 2 illustrates a table of Firm Category 200. Firm Category 200 has a Firm Code 202. A Firm Code 202 identifies a specific firm or business entity. Firm Category 200 also includes at least one Firm Attribute 204. A Firm Attribute 204 may include, but is not limited to, a principal office address, information for an administrative contact, a historical or operations fact, or any differentiator that would be useful to specifically define a firm as a unique entity. While Firm Category 200 is shown with two defined Firm Attributes 204 and 206, the number of Firm Attributes is infinitely expandable and is illustrated by Firm Attribute 208. Codes 210 of Firm Code 202 and Firm Attributes 204, 206 and 208 can be alphanumeric, binary, hexagonal, decimal code or octagonal code or any other code capable of distinguishing on attribute from another. The Firm Category index can include non-broker/dealers.

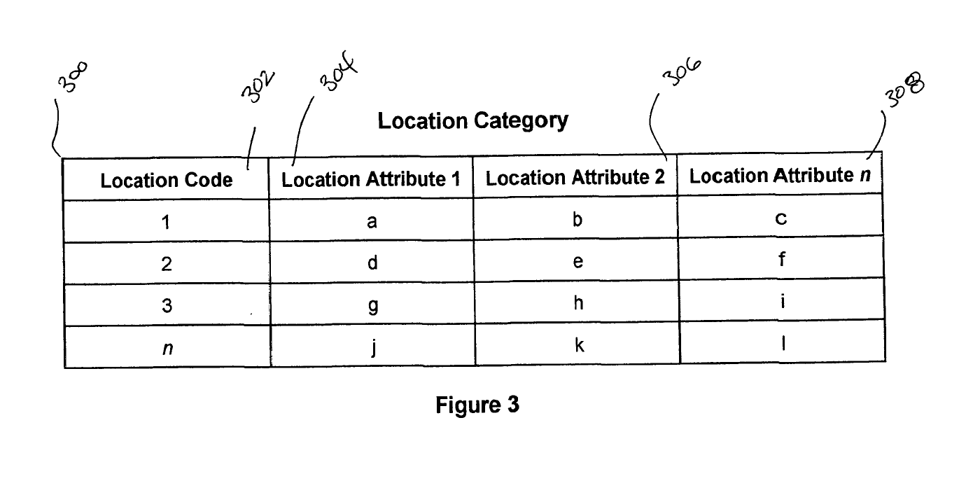

FIG. 3 illustrates a table of Location Category 300. Location Category 300 has a Location Code 302. Location Code 302 identifies a specific geographical location. Location Category 300 also includes at least one Location Attribute 304. Location Attribute 304 can be a physical address, information for an administrative contact, or any descriptive or geographical discriminator that further defines a specific location as a unique entity While Location Category 300 is shown with two defined Location Attributes 304 and 306, the number of Location Attributes is infinitely expandable and is illustrated by Location Attribute 308. Codes 310 of Location Code 302 and Location Attributes 304, 306 and 308 can be alphanumeric, binary, hexagonal, decimal code or octagonal code or any other code capable of distinguishing on attribute from another.

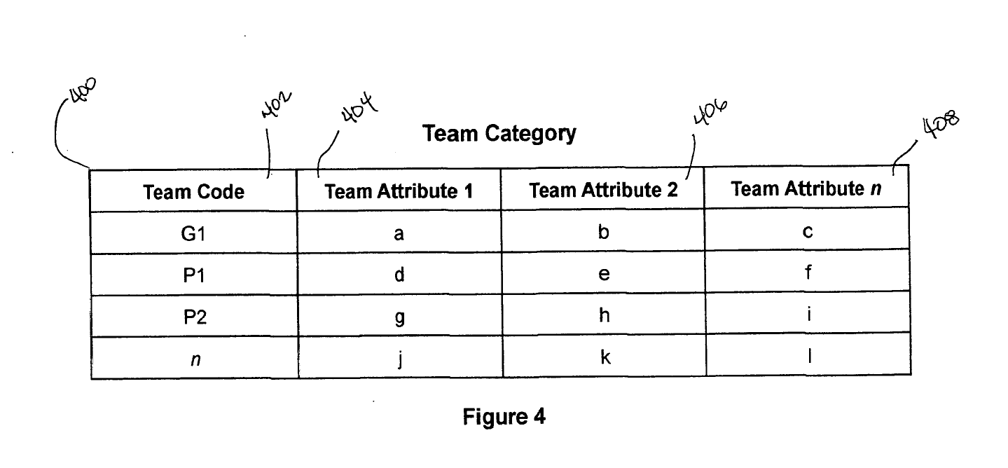

FIG. 4 illustrates a table of Team Category 400. Location Category 400 has a Team Code 402. Team Code 402 identifies a unique team of two or more individuals with either a revenue sharing arrangement or a functional working relationship. Team Category 400 also includes at least one Team Attribute 404. Team Attribute 404 may include the name of a group, information for an administrative contact, a physical or virtual address, a service specialty, an operations discriminator, a revenue split percentage, or any differentiator that would be useful to specifically define a team as a unique entity. While Team Category 400 is shown with two defined Team Attributes 404 and 406, the number of Team Attributes is infinitely expandable and is illustrated by Team Attribute 408. Codes 410 of Team Code 402 and Team Attributes 404, 406 and 408 can be alphanumeric, binary, hexagonal, decimal code or octagonal code or any other code capable of distinguishing on attribute from another. Team Category index can be coded to identify groups and partnerships.

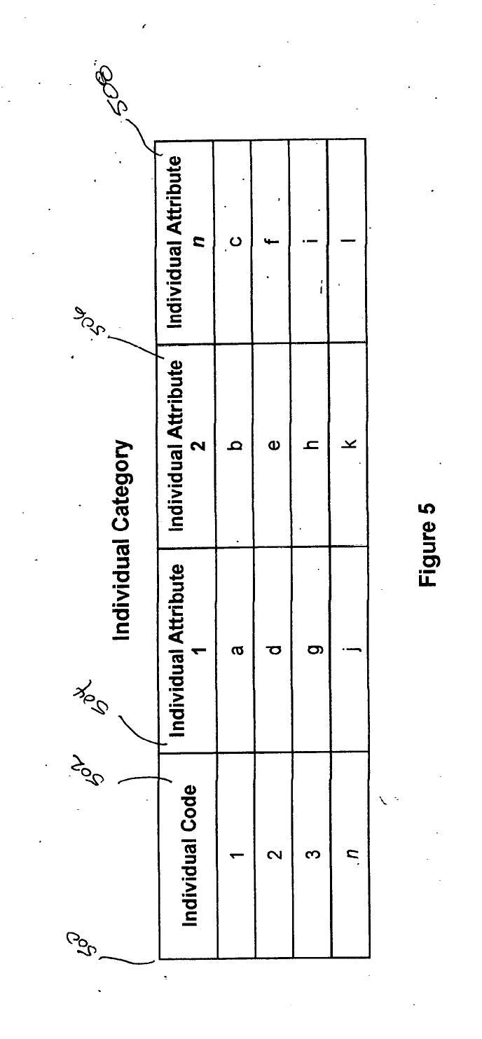

FIG. 5 illustrates a table of Individual Category 500. Individual Category 500 has an Individual Code 502. Location code 502 identifies a unique individual. Individual Category 500 also includes at least one Individual Attribute 504. Individual Attribute 504 can be a physical or virtual address, other contact information, a qualification, title, or role, or any historical, behavioral, or factual attributes that serve to further define an individual as a unique entity. While Individual Category 500 is shown with two defined Individual Attributes 504 and 506, the number of Individual Attributes is infinitely expandable and is illustrated by Individual Attribute 508. Codes 510 of Individual Code 502 and Individual Attributes 504, 506 and 508 can be alphanumeric, binary, hexagonal, decimal code or octagonal code or any other code capable of distinguishing on attribute from another.

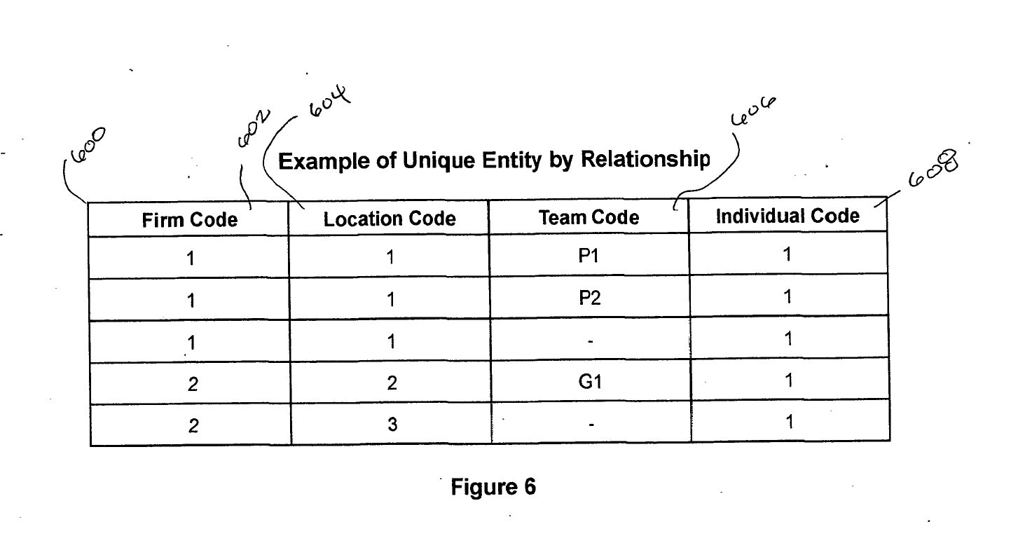

FIG. 6 is a table illustrating Unique Entity 600. Unique Entity 600 in this example is comprised of the four categories and the resulting codes, namely, Firm Code 202, Location Code 302, Team Code 402, and Individual Code 502 discussed supra. By combining the assigned codes, each row depicted represents a unique entity. Further, the Individual Code 502 in this example represents the same individual across all rows, illustrating the common complexity of current industry working relationships. Though the Unique Entity 600 is described herein as being comprised of four codes, it should be known that Unique Entity 600 could be comprised with more or fewer codes from more or fewer categories than discussed in the previous embodiment. Moreover, the additional codes can be alphanumeric, binary, hexagonal, decimal code or octagonal code or any other code capable of distinguishing on attribute from another.

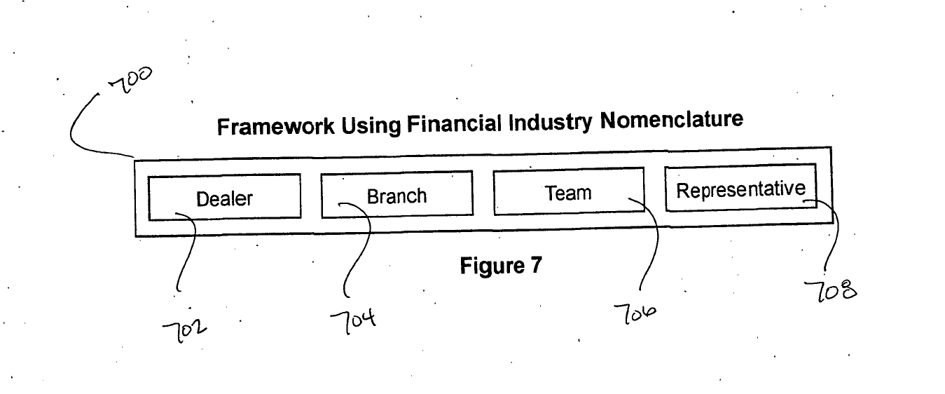

FIG. 7 is an architectural diagram illustrating the same framework used for identifying individual relationships as shown in FIG. 1, but with a Framework 700 having category names customized for the financial services industry. The four categories in FIG. 7 are named Dealer (D) 702, Branch (B) 704, Team (T) 706, and Representative (R) 708 to reflect language germane to the financial services industry.

By creating codes for each category (i.e., Firm, Location, Team, and Individual), attributes using this method may be assigned and maintained as separate entities within each category. Individual professional movement does not affect an attribute or record assigned to another category. Further, category codes may be joined as needed to identify specific relationships for any combination across categories to succinctly define a unique entity and identify a specific working relationship. The method will therefore simplify record maintenance, help eliminate confusion due to duplicate records, and enable more accurate record keeping related to the actions an individual professional performs on behalf of a specific well-defined working relationship.

The present invention method is unique when compared with other known processes and solutions in that it simplifies record maintenance by allowing category changes that can apply to multiple relationships. For instance, during a merger, an office may maintain all of its previous attributes and personnel. The only change for the office may be the firm affiliation, which can be modified using our method by combining the established Location code with a different Firm code to indicate a new relationship—every individual associated with that office can therefore be updated immediately with the new firm relationship without the need to modify or replace other records.

Separately, the present invention allows for detailed attributes to be assigned to teaming relationships for both Groups and Partnerships so that information can be gathered and assessed for these particular teaming entities. The inclusion of any non-licensed support staff, and non-registered independent professionals in the Individual Category 500 can also be identified as belonging to a team by including their Individual code as part of the Unique Entity code 600. Still further, the present invention enables the definition of new entities for individuals by combining codes across categories. Attributes can be assigned to individuals based on particular working relationships, allowing for more complete and accurate record keeping.

While the method was invented for the purpose of advanced record keeping, appending and matching information to the coded framework proves valuable. Numerical values could be appended for sales transactions, fees, assets, and other types of data that would yield information specific to individuals as they relate to other financial services entities. The resulting information could be used for assessing payments and analysis for the purpose of profiling, segmenting, investigating, or performance reporting. The method was created for identifying relationships in the financial services industry, but there are other industries with similar business relationships where the use of the same framework and coding methodology for selected categories may be advantageous, especially in a circumstance where an individual has multiple working relationships with other entities, including but not limited to attorneys, real estate professionals, and insurance professionals.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A method for identifying relationships between service professionals and service entities, the method comprising:
Creating a first unique code for a first category;
Assigning the first code to the first category;
Creating a n^{th} unique code for a nth category;
Assigning the n^{th} unique code to the nth category;
Combining at least first and nth codes; and
Producing a unique identifier identifying a unique entity based on combination of the at least first and n^{th} codes.

2. The method of claim 1, wherein in the first code is any one of an alphanumeric, binary, hexagonal, decimal code or octagonal code or any other code capable of distinguishing on attribute from another.

3. The method of claim 1, wherein in the “nth” code is any one of an alphanumeric, binary, hexagonal, decimal code or octagonal code or any other code capable of distinguishing on attribute from another.

4. The method of claim 1, wherein the assigning of the first unique code to the first category is performed manually.

5. The method of claim 1, wherein the assigning of the first unique code to the first category is performed electronically.

6. The method of claim 1, wherein the assigning of the nth unique code to the nth category is performed manually.

7. The method of claim 1, wherein the assigning of the nth unique code to the nth category is performed electronically.

8. The method of claim 1, wherein the combining of the at least first and nth codes is performed manually.

9. The method of claim 1, wherein the combining of the at least first and nth codes is performed electronically.

10. The method of claim 1, wherein the production of the unique identifier identifying unique entity based on combination of the at least first and “nth” codes is performed manually.

11. The method of claim 1, wherein the production of the unique identifier identifying unique entity based on combination of the at least first and “nth” codes is performed electronically.

12. The method of claim 1 further comprising, assigning attributes to one or more entities in a category.

13. The method of claim 1 further comprising, cataloging the assigned attributes according a unique category code for each of the assigned attributes.

14. The method of claim 1 further comprising, dividing category codes to further indicate a more specific relationship within a category.

15. An apparatus capable of identifying relationships between service professionals and service entities, the apparatus comprising:
Means for creating a first unique code for a first category;
Means for assigning the first code to the first category;
Means for creating a nth unique code for a nth category;
Means for assigning the nth unique code to the nth category;
Means for combining at least first and nth codes; and
Means for producing an unique identifier identifying an unique entity based on combination of the at least first and nth codes.
